(19) United States
(12) Patent Application Publication
(10) Pub. No.: US 2008/0192037 A1
(43) Pub. Date: Aug. 14, 2008

(54) DISPLAY DEVICE

(75) Inventors: Joo-Hyung LEE, Gwacheon-si (KR); Hyung-Guel KIM, Yongin-si (KR); Kee-Han UH, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 11/932,932

(22) Filed: Oct. 31, 2007

(30) Foreign Application Priority Data
Feb. 13, 2007 (KR) 10-2007-0014722

(51) Int. Cl. G09G 5/00

(52) U.S. Cl. 345/205; 345/1.3

(57) ABSTRACT

The display device includes a first display panel, a second display panel and an integration chip. The first display panel includes a plurality of pixels, each pixel of the plurality of pixels having a switching element, and a plurality of gate lines and a plurality of data lines respectively connected to the switching element. The second display panel includes a plurality of X electrode lines and a plurality of Y electrode lines. The integration chip is attached to the first display panel and drives the first and second display panels. The first display panel and the second display panel respectively include different driving schemes.

This application claims priority to Korean Patent Application No. 10-2007-0014722, filed on Feb. 13, 2007, and all the benefits accruing therefrom under 35 U.S.C. §119, the contents of which in its entirety are herein incorporated by reference.

### BACKGROUND OF THE INVENTION

(a) Field of the Invention

The present invention relates to a display device, and more particularly, to a display device capable of simultaneously driving different display panels.

(b) Description of the Related Art

Recently, instead of heavy and large cathode ray tubes (“CRTs”), flat panel displays such as an organic light emitting diode (“OLED”) display, a plasma display panel (“PDP”) and a liquid crystal display (“LCD”) have been actively developed.

The PDP is a display device for displaying characters or images using plasma generated by gas discharge, and the OLED display displays characters or images using an electric field to cause a specific organic material or a high polymer to emit light. The LCD applies an electric field to a liquid crystal layer disposed between two substrates and regulates a magnitude of the electric field so as to regulate a transmittance of light passing through the liquid crystal layer, thereby realizing desired images.

Of the display devices mentioned above, a dual display device, that includes both a small and a medium sized display unit, corresponding to an outside and an inside, respectively, and is used for mobile phones, etc., has been actively developed.

The dual display device as described above includes a main display panel unit mounted therein, an externally mounted sub-display panel unit, a driving flexible printed circuit (“FPC”) film having wiring for transferring an externally input signal, an auxiliary FPC that connects the main display panel and the sub-display panel and a main driving chip and a sub-driving chip for controlling the above-mentioned elements, respectively.

Of the dual display devices, the LCD includes a display panel including pixels each having a switching element and a display signal line, a gate driver that transmits a gate-on voltage and a gate-off voltage to a gate line of the display signal line in order to turn on/off the switching element of the pixel and a data driver that transmits a data voltage to a data line of the display signal line so that the data voltage is applied to the pixel through the turned-on switching element.

The main and sub-driving chips generate a control signal and a driving signal for driving the main display panel and the sub-display panel, and are typically mounted in a chip-on-glass (“COG”) format in the respective display panels.

The main display panel and the sub-display panel may require different driving schemes. For example, the main display panel employs an active matrix scheme so that respective pixels in the main display panel operate independently, and the sub-display panel employs a simple or passive matrix scheme so that respective pixels in the sub-display panel do not operate independently.

Thus, due to such differences in driving schemes, separate chips are required for driving the main display panel and the sub-display panel, thereby increasing manufacturing costs as well as increasing a size of the sub-display panel.

### BRIEF SUMMARY OF THE INVENTION

The present invention provides a display device having an advantage of simultaneously driving two different display panels using a single integration chip.

An exemplary embodiment of the display device according to the present invention includes a first display panel, a second display panel and an integration chip. The first display panel includes a plurality of pixels, each pixel of the plurality of pixels having a switching element, and a plurality of gate lines and a plurality of data lines respectively connected to the switching element. The second display panel includes a plurality of X electrode lines and a plurality of Y electrode lines. The integration chip is attached to the first display panel and drives the first and second display panels. The first display panel and the second display panel respectively include different driving schemes.

In an exemplary embodiment, the first display panel may be operated by an active matrix scheme and the second display panel may be operated by a passive matrix scheme.

In another exemplary embodiment, the plurality of X electrode lines may extend substantially in a first direction and the plurality of Y electrode lines may extend substantially in a second direction.

In another exemplary embodiment, the plurality of gate lines and the plurality of data lines of the first display panel may respectively correspond to the plurality of X electrode lines and the plurality of Y electrode lines of the second display panel.

In another exemplary embodiment, a width of each electrode line of the plurality of X electrode lines and the plurality of Y electrode lines may be larger than a width of each gate line of the plurality of gate lines and each data line of the plurality of data lines.

In another exemplary embodiment, a number of data lines of the plurality of data lines may be connected to the plurality of Y electrode lines.

In another exemplary embodiment, the integration chip may include a gray voltage generator, a data driver and a selection voltage generator. The gray voltage generator generates a plurality of gray voltages. The data driver generates a data voltage applied to the plurality of data lines. The selection voltage generator generates a selection voltage applied to the plurality of X electrode lines.

In another exemplary embodiment, the data driver may include a digital-to-analog converter and a pulse width modulator. The digital-to-analog converter selects a voltage corresponding to a data signal for the first display panel among the plurality of gray voltages, and outputs the selected gray voltage as the data voltage. The pulse width modulator pulse width modulates a voltage corresponding to a data signal for the second display panel among the plurality of gray voltages and outputs the pulse width modulated voltage.

In another exemplary embodiment, the integration chip may further include a switching unit connected to the digital-to-analog converter and the pulse width modulator and outputs at least one of the data voltage and the pulse width modulated voltage according to a switching control signal.

In another exemplary embodiment, the integration may further include an output buffer connected to the switching unit.

In another exemplary embodiment, the display device may further include a gate driver which generates a gate signal and applies the gate signal to the plurality of gate lines. The gate driver may be integrated with the first display panel.

In another exemplary embodiment, the integration chip may include a direct current to direct current (“DC/DC”) converter which generates a driving voltage applied to the gray voltage generator and the gate driver.

In another exemplary embodiment, the display device may further include a first circuit board and a second circuit board. The first circuit board may be attached to one side of the first display panel, and the second circuit board may be attached to another side of the first display panel and one side of the second circuit board.

In another exemplary embodiment, the first and second circuit boards may be provided as flexible printed circuit films.

In other exemplary embodiments, the display device may be provided as a liquid crystal display, or the switching element of each pixel may be made of amorphous silicon.

In another exemplary embodiment, at least one of the first display panel and the second display panel may include at least one polarizer.

### BRIEF DESCRIPTION OF THE DRAWINGS

The accompanying drawings briefly described below illustrate exemplary embodiments of the present invention, and, together with the description thereof, serve to describe the above and other aspects, features and advantages of the present invention, in which:

FIG. 1 is a schematic diagram of an exemplary embodiment of a liquid crystal display (“LCD”) according to the present invention;

FIG. 2 is a block diagram of an exemplary embodiment of an LCD according to the present invention;

FIG. 3 is an equivalent circuit schematic diagram of an exemplary embodiment of an LCD according to the present invention;

FIG. 4 is a top plan schematic block diagram view of an exemplary embodiment of a sub-display panel of FIG. 1;

FIG. 5 is a schematic block diagram of an exemplary embodiment of an integrated chip of FIG. 1;

FIG. 6 is a waveform diagram of a signal generated by the exemplary embodiment of an integrated chip and applied to the exemplary embodiment of a sub-display panel; and

FIG. 7 exemplarily illustrates an image displayed on the exemplary embodiment of a sub-display panel when the signal illustrated in FIG. 6 is applied.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

The present invention will be described more fully hereinafter with reference to the accompanying drawings, in which exemplary embodiments of the invention are shown.

A display device according to an exemplary embodiment of the present invention will now be described in further detail with reference to the accompanying drawings, and a liquid crystal display (“LCD”) will be exemplarily described.

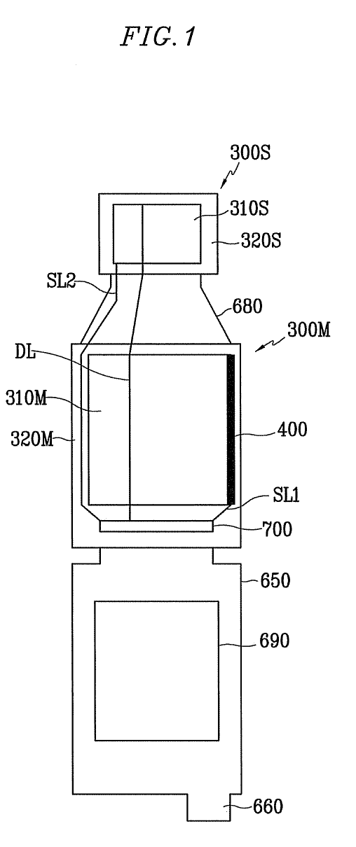

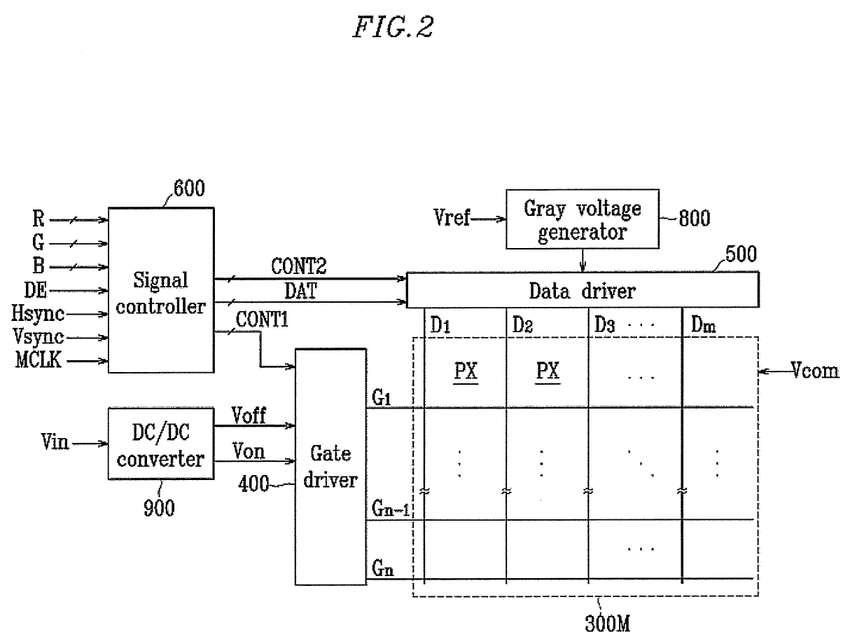

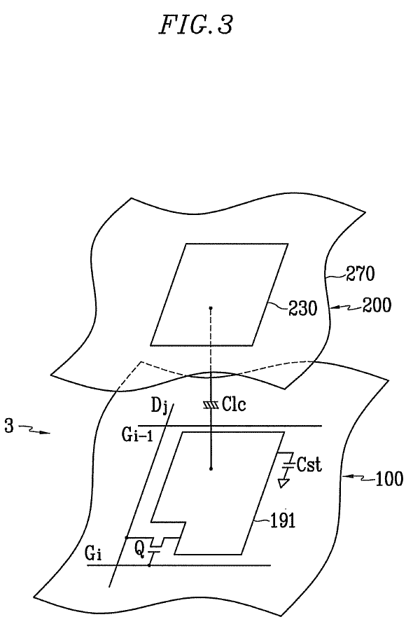

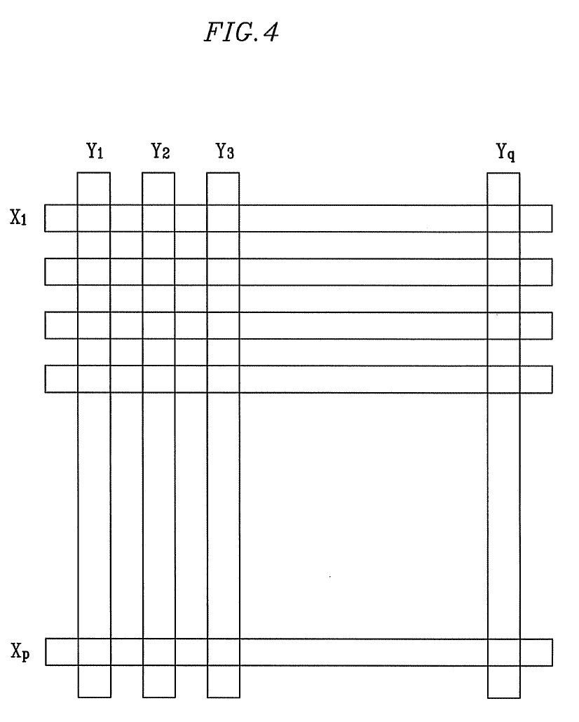

FIG. 1 is a schematic diagram of an exemplary embodiment of an LCD according to the present invention, FIG. 2 is a block diagram of an exemplary embodiment of an LCD according to the present invention, FIG. 3 is an equivalent circuit schematic diagram of an exemplary embodiment of an LCD according to the present invention and FIG. 4 is a schematic block diagram of an exemplary embodiment of a sub-display panel of FIG. 1.

Referring to FIG. 1, an LCD according to an exemplary embodiment of the present invention includes a main display panel 300M, a sub-display panel 300S, a flexible printed circuit film (“FPC”) 650 attached to the main display panel 300M, an auxiliary FPC 680 attached between the main display panel 300M and the sub-display panel 300S and an integration chip 700 mounted on the main display panel 300M.

The FPC 650 is attached to one side of the main display panel 300M. In addition, the FPC 650 includes an opening 690 which exposes a portion of the main display panel 300M when the FPC 650 is folded in an assembled state. Referring to FIG. 1, an input section 660, used for inputting an external signal, is provided in a lower portion of the opening 690, and a plurality of signal lines (not shown) are provided between the input section 660 and the integration chip 700 and between the integration chip 700 and the main display panel 300M, to establish electrical connections therebetween. That is, the plurality of signal lines establishes electrical connections between the input section 660 and the integration chip 700, and between the integration chip 700 and the main display panel 300M. The plurality of signal lines form a pad (not shown) including a wider width at a portion which is connected to the integration chip 700 and at a portion which is attached to the main display panel 300M.

The auxiliary FPC 680 is attached to another side of the main display panel 300M and to one side of sub-display panel 300S, and includes signal lines SL2 and DL, which electrically connect the integration chip 700 to the sub-display panel 300S.

The main display and sub-display panels 300M and 300S respectively include a display area 310M and 310S, which form a screen and peripheral areas 320M and 320S. In exemplary embodiments, the peripheral areas 320M and 320S may include a light blocking layer (not shown), such as a black matrix, to block light. The FPC 650 and the auxiliary FPC 680 are respectively attached to the peripheral areas 320M and 320S.

As shown in FIG. 2, the main display panel 300M includes a plurality of display signal lines including a plurality of data lines D₁ to Dm and a plurality of gate lines G₁ to Gₙ, a plurality of pixels PX connected to the plurality of display signal lines and arranged substantially in a matrix form and a gate driver 400 which supplies signals to the plurality of gate lines G₁ to Gₘ. A majority of the pixels PX and the display signal lines G₁ to Gₙ and D₁ to Dₘ are positioned within the display area 310M, and the gate driver 400 is positioned in the peripheral area 320M. The gate driver 400 is positioned in an area which is wider than the rest of the area of the peripheral area 320M.

In addition, as shown in FIG. 1, some of the plurality of data lines D₁ to Dₘ of the main display panel 300M are connected to the sub-display panel 300S through the auxiliary FPC 680. That is, the two display panels 300M and 300S partially share the plurality of data lines D₁ to Dₘ, and the signal line DL is one of the shared data lines.

In an exemplary embodiment, each pixel PX of the main display panel 300M, for example a pixel PX connected to an i-th gate line Gᵢ (i=1, 2, . . . , n) and a j-th data line Dⱼ (j=1,2, . . . , m) includes a switching element Q connected to the display signal lines Gᵢ and Dⱼ, a liquid crystal capacitor Clc and a storage capacitor Cst. In alternative exemplary embodiments, the storage capacitor Cst may be omitted as necessary.

Referring to FIG. 3, the switching element Q is a three terminal element, such as a thin film transistor (“TFT”), which is provided on a lower substrate 100. A control terminal, such as a gate electrode, of the switching element Q is connected to the gate line Gᵢ, an input terminal, such as a source electrode, of the switching element Q is connected to the data line Dⱼ and an output terminal, such as a drain electrode, of the switching element Q is connected to the liquid crystal capacitor Clc and the storage capacitor Cst.

The liquid crystal capacitor Clc includes a pixel electrode 191, as a first terminal, provided on the lower substrate 100 and a common electrode 270, as a second terminal, provided on an upper substrate 200, and a liquid crystal layer 3 disposed between the pixel electrode 191 and the common electrode 270 functions as a dielectric material. The pixel electrode 191 is connected to the switching element Q, and the common electrode 270 is formed on a portion of or over an entire surface of the upper panel 200 and is supplied with a common voltage Vcom. In alternative exemplary embodiments, the common electrode 270 may be provided on the lower substrate 100, and at least one of the pixel electrode 191 and the common electrode 270 are formed in a linear or bar shape.

The storage capacitor Cst, which assists the liquid crystal capacitor Clc, is formed by overlapping a separate signal line (not shown) and the pixel electrode 191 provided on the lower substrate 100 with an insulator interposed therebetween, and the separate signal line is supplied with a predetermined voltage, such as a common voltage Vcom. In alternative exemplary embodiments, the storage capacitor Cst may be formed by overlapping the pixel electrode 191 and a previous upper gate line Gᵢ₋₁ an insulator disposed therebetween.

Based on a passive matrix driving scheme, the sub-display panel 300S includes a plurality of X electrode lines X₁ to Xₚ formed on a lower substrate (not shown), which extends substantially in a first direction, such as a horizontal direction and a plurality of Y electrode lines Y₁ to Y_{q} formed on an upper panel, which extends substantially in a second direction, such as a vertical direction, as shown in FIG. 4. In exemplary embodiments, the plurality of X electrode lines X₁ to Xₚ and the plurality of Y electrode lines Y₁ to Y_{q} may respectively correspond to the plurality of gate lines G₁ to Gₙ and the plurality of data lines D₁ to Dₘ of the main display panel 300M. However, a width of each of the respective electrode lines X₁ to Xₚ and Y₁ to Y_{q} is larger than that of each of the gate lines G₁ to Gₙ and the data lines D₁ to Dₘ.

A pixel (not shown) of the sub-display panel 300S is formed in an area where each of the X electrode lines X₁ to Xₚ and each of the Y electrode lines Y₁ to Y_{q} overlap, and does not include the switching element Q and the pixel electrode 191, unlike the pixel PX of the main display panel 300M.

In order to display a color, each pixel PX uniquely displays one color of primary colors (e.g., spatial division) or in alternative exemplary embodiments, each pixel PX displays all of the primary colors in turn accordance with time (e.g., temporal division), such that a desired color can be recognized by a spatial or temporal sum of the primary colors. An exemplary set of the primary colors includes red, green and blue colors. FIG. 3 exemplarily illustrates the spatial division in which each pixel PX includes a color filter 230 representing one of the primary colors in an area of the upper substrate 200 corresponding to the pixel electrode 191. In alternative exemplary embodiments, the color filter 230 may be provided above or below the pixel electrode 191 of the lower substrate 100.

In exemplary embodiments, the main display panel 300M and the sub-display panel 300S respectively include at least one polarizer (not shown).

The DC/DC converter 900 generates various driving voltages such as a reference voltage Vref for the gray voltage generator 800, a gate-on voltage Von and a gate-off voltage Voff, by using an external input voltage Vin.

A gray voltage generator 800 generates all gray voltages related to a transmittance of the pixels PX or a limited number of gray voltages by using the reference voltage Vref. Hereinafter, the gray voltage will be referred to as a “reference gray voltage”. In exemplary embodiments, the reference gray voltage may include a positive value or a negative value with respect to the common voltage Vcom.

Referring to FIGS. 1 and 2, the gate driver 400 is connected to the plurality of gate lines G₁ to Gₙ of the liquid crystal panel assembly 300 and applies a gate signal formed by a combination of the gate-on voltage Von and the gate-off voltage Voff to the plurality of gate lines G₁ to Gₙ. In exemplary embodiments, the gate driver 400 may be formed in the same process as that in which the switching element Q of the pixel PX is formed. The gate driver 400 is connected to the integration chip 700 via the signal line SL1.

A data driver 500 is connected to the plurality of data lines D₁ to Dₘ of the liquid crystal panel assembly 300, and selects a reference gray voltage from the gray voltage generator 800 and applies the selected reference gray voltage as a data voltage to the plurality of data lines D₁ to Dₘ. However, when the gray voltage generator 800 does not provide all the required gray voltages but instead provides a predetermined number of reference gray voltages, the data driver 500 divides the reference gray voltages in order to generate a desired data voltage.

A signal controller 600 controls the gate driver 400 and the data driver 500.

The integration chip 700 receives and processes external signals through the input section 660 and signal lines (not shown) provided in the FPC 650. The integration chip 700 provides the processed signals to the main display panel 300M and the sub-display panel 300S through the peripheral area 320M of the main display panel 300M and wiring provided in the auxiliary FPC 680, thereby controlling the main display panel 300M and the sub-display panel 300S. The integration chip 700 includes a DC/DC converter 900, the gray voltage generator 800, the data driver 500, the signal controller 600 and so on, which are shown in FIG. 2.

An exemplary embodiment of a display operation of the exemplary LCD described above will now be described in further detail.

The signal controller 600 receives input image signals R, G and B from an external graphics controller (not shown) and input control signals for controlling the display of the input image signals R, G and B. The input image signals R, G and B include luminance information for each pixel PX, and the luminance information includes a predetermined number of gray levels, e.g., 1024 (=2¹⁰), 256 (=2⁸), or 64 (=2⁶) gray levels. Exemplary embodiments of the input control signals may include a vertical synchronization signal Vsync, a horizontal synchronizing signal Hsync, a main clock signal MCLK and a data enable signal DE.

Referring to FIG. 2, the signal controller 600 processes the input image signals R, G and B based on the input image signals R, G and B and the input control signals in such a way so as to be suitable for an operating condition of the liquid crystal panel assembly 300, generates a gate control signal CONT1 and a data control signal CONT2 and transmits the data control signal CONT2 and a processed image signal DAT to the data driver 500.

The gate control signal CONT1 includes a scanning start signal STV indicating a scanning start, and at least one clock signal to control an output cycle of the gate-on voltage Von. In an exemplary embodiment, the gate control signal CONT1 may further include an output enable signal OE used to define a sustain period of the gate-on voltage Von.

The data control signal CONT2 includes a horizontal synchronization start signal STH, which informs the pixel PX of one row of a start of transmission of image data, and a load signal LOAD and a data clock signal to instruct an analog data voltage to be applied to the plurality of data lines D₁ to Dₘ. In an exemplary embodiment, the data control signal CONT2 may further include an inversion signal RVS for inverting a voltage polarity of the data signal for the common voltage Vcom (hereinafter, “the voltage polarity of the data signal for the common voltage” will be abbreviated to “the polarity of the data signals”).

The data driver 500 receives the digital image signal DAT with respect to the pixel PX of one row in response to the data control signal CONT2 from the signal controller 600, selects a gray voltage corresponding to each digital image signal DAT, converts the digital image signal DAT into an analog data voltage and then applies the converted voltage to corresponding data lines D₁ to Dₘ.

The gate driver 400 applies the gate-on voltage Von to the plurality of gate lines G₁ to Gₙ in response to the gate control signal CONT1 from the signal controller 600, thereby turning on the switching element Q connected to the plurality of gate lines G₁ to Gₙ. Accordingly, the data voltage applied to the plurality of data lines D₁ to Dₘ is applied to a corresponding pixel PX through the turned-on switching element Q.

A difference between a data voltage applied to the pixel PX and the common voltage Vcom appears as a charge voltage of the liquid crystal capacitor Clc, e.g., a pixel voltage. Liquid crystal molecules are oriented according to a magnitude of the pixel voltage, and a polarization of light passing through the liquid crystal layer 3 is changed accordingly. Variation in such polarization appears as variations in the transmittance of light by means of a polarizer, and the pixel PX displays luminance represented by a gray level of the image signal DAT.

In the sub-display panel 300S, a voltage difference between a voltage (hereinafter referred to as an “X voltage”) applied to the plurality of X electrode lines X₁ to Xₚ and a voltage applied to the plurality of Y electrodes Y₁ to Y_{q} causes an alignment of liquid crystal molecules disposed therebetween to be changed, and accordingly, a polarization of light passing through the liquid crystal layer 3 is changed.

The above mentioned processes are repeated for each horizontal period (this is also referred to as “1H”, the same as one cycle of the horizontal synchronizing signal Hsync and the data enable signal DE) such that the gate-on voltage Von is applied sequentially to all the gate lines G₁ to Gₙ and the data signal is applied to all the pixels PX, to thereby display an image of one frame.

When one frame is finished, a next frame begins, and the state of the inversion signal RVS applied to the data driver 500 is controlled (“frame inversion”) such that a polarity of the data signal applied to each pixel PX becomes opposite to that in the previous frame. In exemplary embodiments, the polarity of the data signal flowing through one data line may be changed (e.g., row inversion, dot inversion) or the polarity of the data signal applied to one pixel row may be different (e.g., column inversion, dot inversion) depending on a characteristic of the inversion signal RVS, even within one frame.

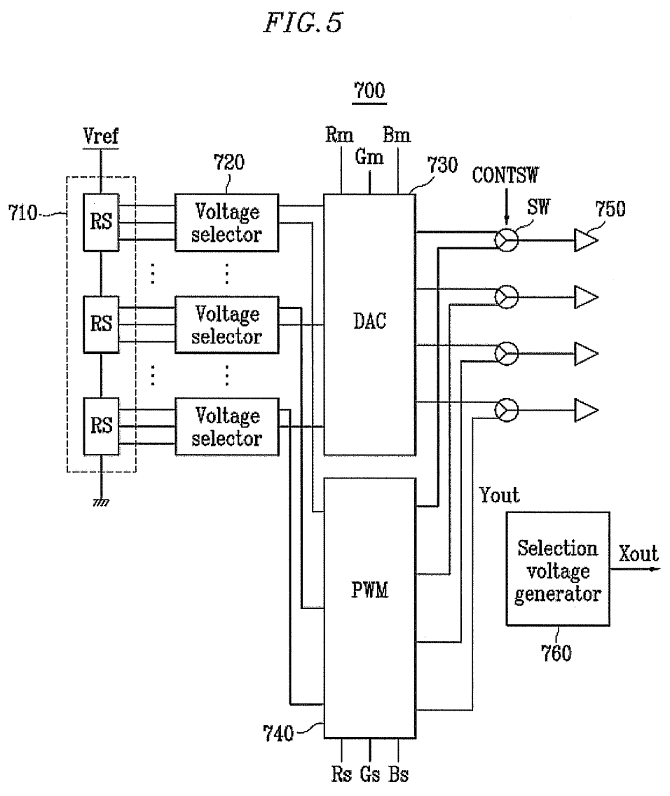

An exemplary embodiment of a driving device of the exemplary LCD according to the present invention will now be described in further detail with reference to FIGS. 5 to 7.

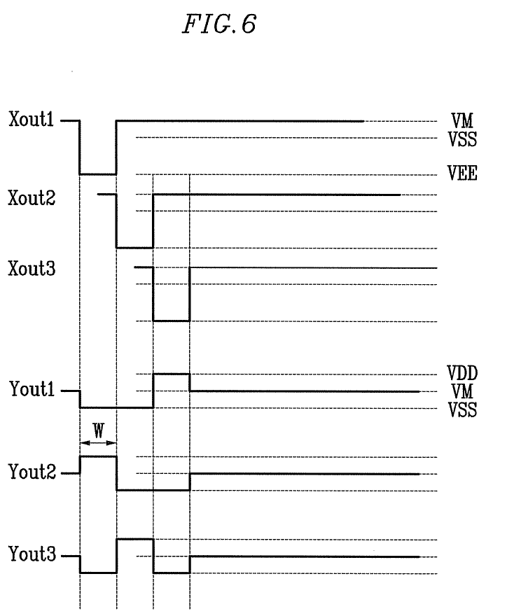

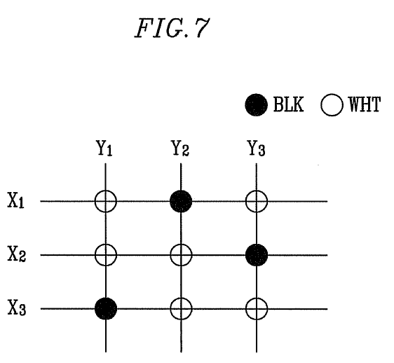

FIG. 5 is a schematic block diagram of the exemplary embodiment of an integrated chip 700 of FIG. 1, FIG. 6 is a waveform diagram of a signal generated by the exemplary embodiment of an integrated chip 700 and applied to the exemplary embodiment of a sub-display panel 300S and FIG. 7 exemplarily illustrates an image displayed on the exemplary embodiment of a sub-display panel 300S when the signal illustrated in FIG. 6 is applied.

Referring to FIG. 5, the exemplary integration chip 700 according to the present invention includes a voltage generator 710, a voltage selector 720 connected to the voltage generator 710, a digital-to-analog converter (“DAC”) 730, a pulse width modulator (“PWM”) 740, a switching unit SW, and an output buffer 750 and further includes a selection voltage generator 760.

The voltage generator 710 is positioned between the reference voltage Vref and a ground voltage, and includes a plurality of resistor series RS, each formed of a plurality of resistors.

The voltage selector 720 which is connected to each resistor series RS, selects one of the voltages generated therefrom, and transmits the selected voltage to the DAC 730 and to the PWM 740.

The DAC 730 receives the voltage from the voltage selector 720 and outputs a voltage corresponding to data signals Rm, Gm and Bm for the main display panel 300M as data voltages.

The PWM 740 receives the voltage from the voltage selector 720 and outputs a pulse width modulated voltage Vout based on data signals Rs, Gs and Bs for the sub-display panel 300S.

In the current exemplary embodiment, the voltage generator 710 and the voltage selector 720 correspond to the previously-described gray voltage generator 800, and the DAC 730 and the PWM 740 correspond to the previously-described data driver 500.

The switching unit SW outputs the data voltage from the DAC 730 or the pulse width modulated voltage Yout from the PWM 740 based on a switching control signal CONTSW.

The selection voltage generator 760 generates a selection voltage Xout for selecting the plurality of X electrode lines X₁ to Xₚ of the sub-display panel 300S and transmits the selection voltage Xout to the plurality of X electrode lines X₁ to Xₚ.

In the current exemplary embodiment, the data voltage is applied to the plurality of data lines D₁ to Dₘ of the main display panel 300M as described above, and the pulse width modulated voltage Yout is applied to the plurality of Y electrode lines Y₁ to Y_{q} of the sub-display panel 300S.

In exemplary embodiments, the selection voltage Xout is between a voltage VM and a voltage VEE, and when the selection voltage Xout corresponds to the voltage VEE, corresponding X electrode lines X₁ to Xₚ are selected.

In addition, the pulse width modulated voltage Yout includes three voltage levels VDD, VM and VSS, and particularly when the voltage Vout corresponds to the voltage VDD, a grayscale can be represented in accordance with a pulse width W. FIG. 6 exemplarily illustrates a case in which the pulse width is maximized. In addition, it is exemplarily illustrated in FIG. 6 that selection voltages Xout1, Xout2 and Xout3 and pulse width modulated voltages Yout1, Yout2 and Yout3 are respectively applied to three X electrode lines X₁ to X₃ and three Y electrode lines Y₁ to Y₃.

If it is assumed that the LCD is a normally white mode display, the first X electrode line X₁ is selected and the pulse width modulated voltages Yout1, Yout2 and Yout3 sequentially correspond to the voltages VSS, VDD and VSS when the selection voltage Xout1 corresponds to the voltage VEE. Herein, when the pulse width modulated voltage corresponds to the voltage VDD which is larger than the middle voltage VM, a difference between the selection voltage VEE and the pulse width modulated voltage VDD is maximized such that black BLK is displayed, and when the pulse width modulated voltage corresponds to the voltage VSS which is less than the middle voltage VM, a difference between the selection voltage VEE and the voltage VSS is minimized such that white WTH is displayed.

As described above, driving circuits (e.g., the PWM 740 and the selection voltage generator 760) for driving the sub-display panel 300S are included in the integration chip 700 such that the two display panels 300M and 300S, each including a different driving scheme, can be simultaneously driven by one chip (e.g., the integration chip 700).

In exemplary embodiments, since the gate-on voltage Von and the gate-off voltage Voff respectively correspond to about 15V and about −8V, and the selection voltage Xout includes a range of about −6V to about 10V, the selection voltage Xout can be generated by dividing the gate-on voltage Von and the gate-off voltage Voff by a resistor, such that an additional DC/DC converter is not required. In addition, since the pulse width modulated voltage Yout corresponds to the data voltage, e.g., between about 0V to about 5V, an existing output buffer 750 can be used as it is. Accordingly, the additional driving circuit for driving the sub-display panel 300S can be included in a single driving chip (e.g., an integration chip 700) without incurring significant additional cost, and the additional cost is significantly less than a cost for manufacturing an additional chip for driving the sub-display panel 300S.

As described above, a driving circuit of a sub-display panel is included in an integration chip 700, such that two display panels, each including different driving schemes, can be simultaneously driven by a single chip. Accordingly, manufacturing costs can be reduced, and a size of the sub-display panel can be reduced as compared to a conventional sub-display panel.

While this invention has been described in connection with what is presently considered to be some practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A display device comprising:
a first display panel having a plurality of pixels, each pixel of the plurality of pixels having a switching element, and a plurality of gate lines and a plurality of data lines connected to the switching element;
a liquid crystal capacitor including a common electrode and a pixel electrode connected to the switching element;
a second display panel having a plurality of X electrode lines and a plurality of Y electrode lines;
a liquid crystal layer disposed between the X electrode and the Y electrode; and
an integration chip attached to the first display panel, the integration chip drives the first and second display panels.

2. The display device of claim 1, wherein the first display panel is operated by an active matrix driving scheme and the second display panel is operated by a passive matrix driving scheme.

3. The display device of claim 1, wherein the plurality of X electrode lines extend substantially in a first direction and the plurality of Y electrode lines extend substantially in a second direction.

4. The display device of claim 1, wherein the plurality of gate lines and the plurality of data lines of the first display panel respectively correspond to the plurality of X electrode lines and the plurality of Y electrode lines of the second display panel.

5. The display device of claim 4, wherein a width of each electrode line of the plurality of X electrode lines and the plurality of Y electrode lines is larger than a width of each gate line of the plurality of gate lines and each data line of the plurality of data lines.

6. The display device of claim 2, wherein a number of data lines of the plurality of data lines are connected to the plurality of Y electrode lines.

7. The display device of claim 6, wherein the integration chip comprises:
a gray voltage generator which generates a plurality of gray voltages;
a data driver which generates a data voltage applied to the plurality of data lines; and
a selection voltage generator which generates a selection voltage applied to the plurality of X electrode lines.

8. The display device of claim 7, wherein the data driver comprises:
a digital-to-analog converter which selects a voltage corresponding to a data signal for the first display panel among the plurality of gray voltages and outputs the selected gray voltage as the data voltage; and
a pulse width modulator which pulse width modulates a voltage corresponding to a data signal for the second display panel among the plurality of gray voltages and outputs the pulse width modulated voltage.

9. The display panel of claim 8, wherein the integration chip further comprises a switching unit connected to the digital-to-analog converter and the pulse width modulator and outputs at least one of the data voltage and the pulse width modulated voltage according to a switching control signal.

10. The display device of claim 9, wherein the integration chip further comprises an output buffer connected to the switching unit.

11. The display device of claim 10, further comprising a gate driver which generates a gate signal and applies the gate signal to the plurality of gate lines,
wherein the gate driver is integrated with the first display panel.

12. The display device of claim 11, wherein the integration chip further comprises a direct current/direct current converter which generates a driving voltage applied to the gray voltage generator and the gate driver.

13. The display device of claim 1, further comprising:
a first circuit board attached to one side of the first display panel; and
a second circuit board attached to another side of the first display panel and to one side of the second display panel.

14. The display device of claim 13, wherein the first and second circuit boards are flexible printed circuit films.

15. The display device of claim 1, wherein the display device is a liquid crystal display.

16. The display device of claim 1, wherein at least one of the first display panel and the second display panels includes at least one polarizer.

17. A driving method for a display device having a first display panel and a second display panel, which comprises operating the first display panel by an active matrix driving scheme; and
operating the second display panel by a passive matrix driving scheme.

18. The driving method of claim 17, wherein the first display panel comprises a plurality of pixels, each pixel of the plurality of pixels having a switching element, a plurality of gate lines and a plurality of data lines connected to the switching element, and a liquid crystal capacitor including a common electrode and a pixel electrode connected to the switching element;
the second display panel comprises a plurality of X electrode lines and a plurality of Y electrode lines, a liquid crystal layer disposed between the X electrode and the Y electrode, and an integration chip attached to the first display panel.

19. The driving method of claim 18, wherein the integration chip drives the first display panel and the second display panel.

20. The driving method of claim 17, wherein the plurality of X electrode lines and the gate lines extend substantially in a first direction and the plurality of Y electrode lines and the data lines extend substantially in a second direction.
